(19) United States
(12) Patent Application Publication
(10) Pub. No.: US 2015/0326620 A1
(43) Pub. Date: Nov. 12, 2015

(54) MEDIA PRESENTATION IN A VIRTUAL SHARED SPACE

(71) Applicant: DROPBOX, INC., San Francisco, CA (US)

(72) Inventors: Anna Lillian Kohnen, San Francisco, CA (US); Joshua Puckett, San Francisco, CA (US)

(73) Assignee: DROPBOX, INC., San Francisco, CA (US)

(21) Appl. No.: 14/270,924

(22) Filed: May 6, 2014

(51) Int. Cl. H04L 29/06; H04L 29/08; H04L 12/58; G06F 3/0484

(52) U.S. Cl. CPC H04L 65/403; G06F 3/04842; H04L 65/60; H04L 67/1095; H04L 51/046; G06F 3/04845

(57) ABSTRACT

Various embodiments of the present technology involve the sharing of media items via a virtual shared space. For example, a user could create and share a slideshow to other users in a presentation mode that includes establishing a shared screen session for simultaneous viewing of the images. Further, while in the presentation mode, interaction with the images by each user could be shown on each device. For example, if a user zooms in on an object, another user will see a magnification of the object. Additionally, if the other user subsequently zooms out, the first user will see a minimization of the object. In another example, an audio message describing one or more images of a slideshow could be provided for playback at a later time when establishing a shared screen session is not available.

### TECHNICAL FIELD

The present technology pertains to sharing media content, and more specifically pertains to methods of presenting the shared media content including providing additional information for and interacting with shared media content.

### BACKGROUND

Social networks enable users to collaborate and share information. Many of these social networks enable users to comment on items, send each other messages, and communicate through chat features. Although these social networks often facilitate direct communication between users, there is a need for improved features for facilitating communication between users as a first user presents media to one or more second users.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for facilitating communication between users while viewing media. In at least one embodiment, a content management system (CMS) providing cloud storage services can additionally provide, among other such services, a forum that allows users to share media items (e.g., images, videos, documents, etc.) with other users. For example, a first user can share an image with a second user to create a virtual shared space between the first and second user. In one example, this virtual shared space is not public and is only accessible by the first and second user until the first or second user invites a third user to join the virtual shared space. Accordingly, the virtual shared space is, in one example, a private media sharing forum between selected or otherwise invited users.

In at least one embodiment, a user could create and share a slideshow of images with other users in the virtual shared space. In addition to enabling users to provide comments to specific images or to the slideshow in general, the slideshow could include a presentation mode where a first user presents the slideshow to the other users in the virtual shared space. In one example, the presentation mode could include establishing a shared screen session for simultaneous viewing where what is being displayed on a first computing device is also being displayed on a second computing device. Further, in this example, interactions with the images of the slideshow by each computing device could be shown on each device. For example, if a first user zooms in on an object, a second user will see a magnification of the object. Additionally, if the second user subsequently zooms out, the first user will see a minimization of the object.

There are, however, instances where simultaneous viewing in the presentation mode may not be convenient for users. Therefore, in another example, a user could provide an audio message describing one or more images of the slideshow for playback at a later time by other users of the virtual shared space.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A shows a first user wishing to share content with a second user through a virtual shared space in accordance with various embodiments;

FIG. 1B shows an example screenshot of a virtual shared space as viewed by the first user in accordance with various embodiments;

FIG. 2A shows a second user receiving content from the first user through a virtual shared space in accordance with various embodiments;

FIG. 2B shows an example screenshot of a virtual shared space as viewed by the second user in accordance with various embodiments;

FIGS. 3A-3E show an exemplary process associated with a first user creating and sharing a slideshow with a second user via a virtual shared space in accordance with at least one embodiment;

FIGS. 4A-4F show exemplary actions associated with simultaneous viewing of a slideshow between a first user and a second user in accordance with at least one embodiment;

FIGS. 5A-5E show exemplary process associated with a first user recording an audio message for a slideshow and sharing the slideshow with a second user via a virtual shared space in accordance with at least one embodiment;

FIG. 6 shows an exemplary process for sharing a slideshow with an audio message via a virtual shared space in accordance with at least one embodiment;

FIG. 7 shows an exemplary process for simultaneous viewing of a slideshow between a first user and a second user in accordance with at least one embodiment;

FIG. 8 shows an exemplary configuration of devices and a network in accordance with the invention;

FIG. 9A shows a conventional system bus computing system architecture; and

FIG. 9B shows a computer system having a chipset architecture.

### DESCRIPTION

Various embodiments of the disclosure are discussed in detail below. While specific implementations are discussed, it should be understood that this is done for illustration purposes only. A person skilled in the art will recognize that other components and configurations may be used without departing from the spirit and scope of the disclosure.

The disclosed technology addresses the need in the art for facilitating communication between users while viewing shared media. In at least one embodiment, a forum allowing users to share media items (e.g., images, videos, documents, etc.) with other users is disclosed. For example, a first user can share an image or other media item with a second user to create a virtual shared space between the first and second user. In one example, this virtual shared space is private between the first and second user and is only accessible by additional users upon invitation.

In at least one embodiment, a user can create and share a slideshow of images with other users in the virtual shared space. For example, the slideshow can include a presentation mode where a first user can present the slideshow to other users of the virtual shared space. In one example, the presentation mode can include establishing a shared screen session for simultaneous viewing where what is being displayed on a first computing device is also being displayed on a second computing device. Alternatively, a user could record an audio message to accompany the slideshow for playback at a later time by the other users of the virtual shared space.

Various other functions and advantages are described and suggested below as may be provided in accordance with the various embodiments.

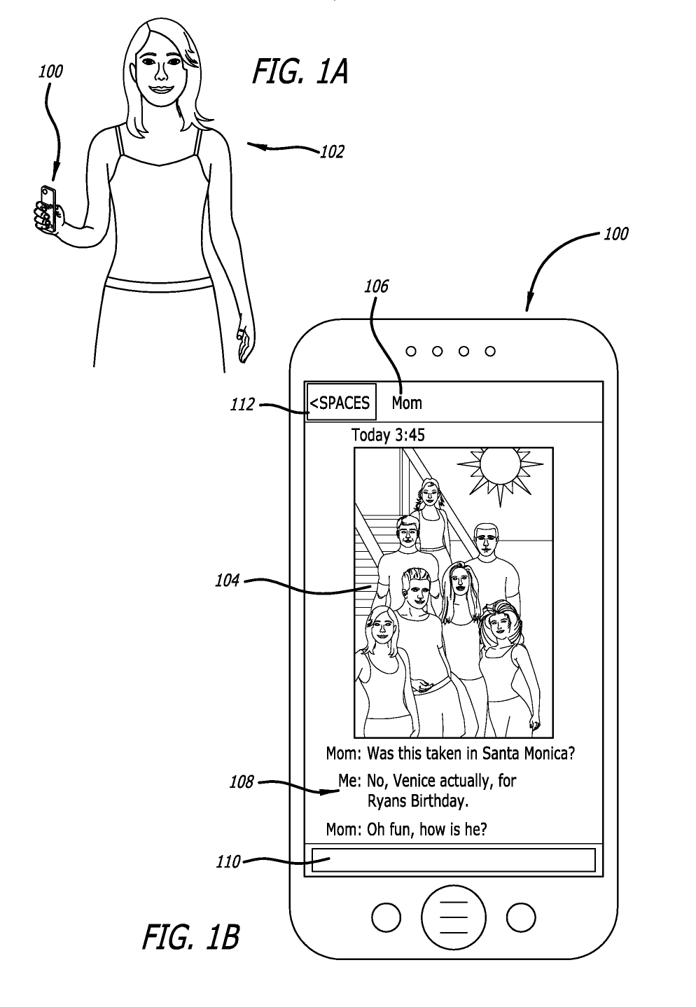

FIG. 1A shows a first user Jane 102 holding computing device 100 in accordance with at least one embodiment. In this example, Jane 102 has captured or otherwise obtained an image that she would like to share with a second user who, in this example, is her mother. Accordingly, in this example, Jane 102 can share the image via an application on computing device 100 through a virtual shared space between Jane 102 and her mom. If the virtual shared space has not yet been created, sharing the image will establish a new virtual shared space between them where they can shared additional media items, comments, messages, and the like. Otherwise, Jane 102 can post or share the image through an existing virtual shared space between her and her mother.

Accordingly, FIG. 1B shows computing device 100 displaying image 104 through virtual shared space 106 which Jane 102 shares with her mother in accordance with at least one embodiment. Although a smartphone is shown, it should be understood that computing device 100 can be any computing device capable of processing input (e.g., desktop computer, laptop computer, television, video game console, etc.). In this example, the application through which virtual shared space 106 is established enables each user to provide comments for a respective media item on comment field 108 by entering text into text field 110. Further, virtual shared space 106 can be one of many virtual shared spaces Jane 102 shares with other users and she can access these other virtual shared spaces by selecting spaces icon 112 from this current view of the application to be presented with a list of her other virtual shared spaces.

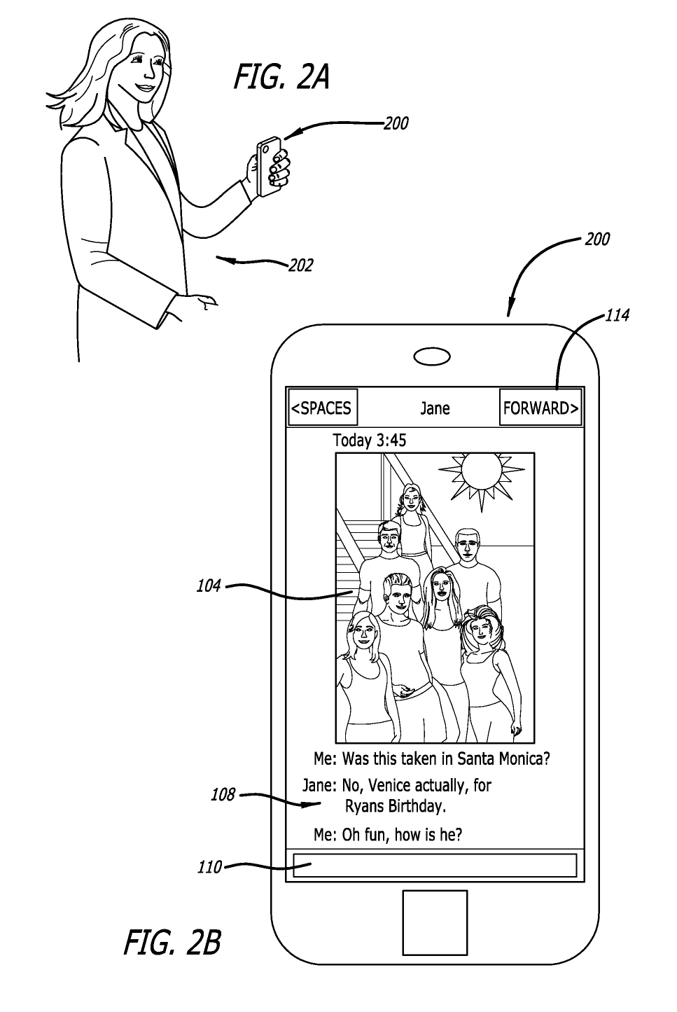

FIG. 2A shows a second user, Jane's mom 202 holding computing device 200 in accordance with at least one embodiment. In this example, Jane 102 has shared or posted image 104 in virtual shared space 106 for mom 202 to view. Accordingly, FIG. 2B shows computing device 200 displaying image 104 in virtual shared space 106 which Jane 102 shares with mom 202 in accordance with at least one embodiment. In this example, mom 202 has provided one or more comments that are displayed in comment field 108 asking questions about image 104 and Jane 102 has replied.

Additionally, mom 202 may have the option of forwarding image 104 to other users by selecting forward icon 114. In one example, mom 202 could forward image 104 and, as a result, create a new virtual shared space, she could forward image 104 to a user which mom 202 already connected with via an existing virtual shared space, or mom 202 could invite an additional user to join virtual shared space 106 between her and Jane 102. In one example, virtual shared space 106 is not public and is only accessible by Jane 102 and mom 202 until either of them invites another user to join virtual shared space 106.

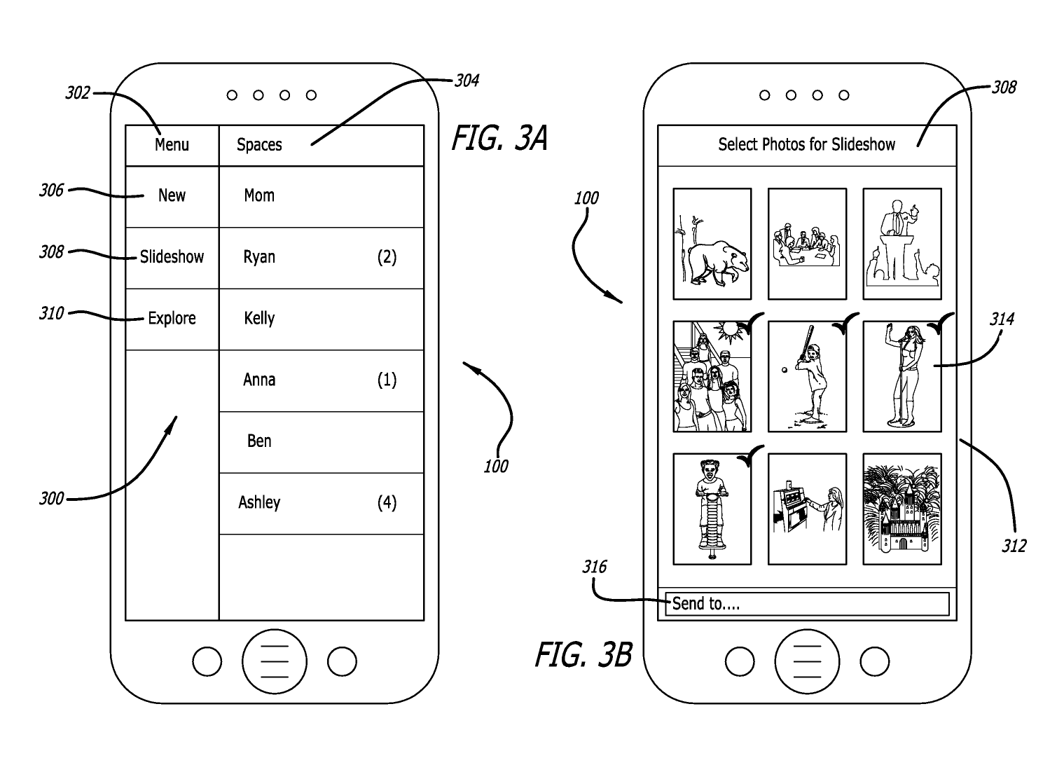

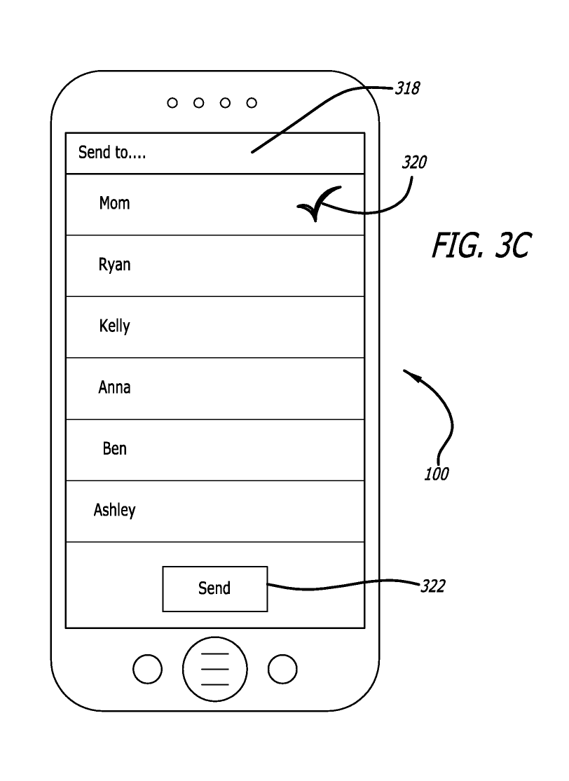

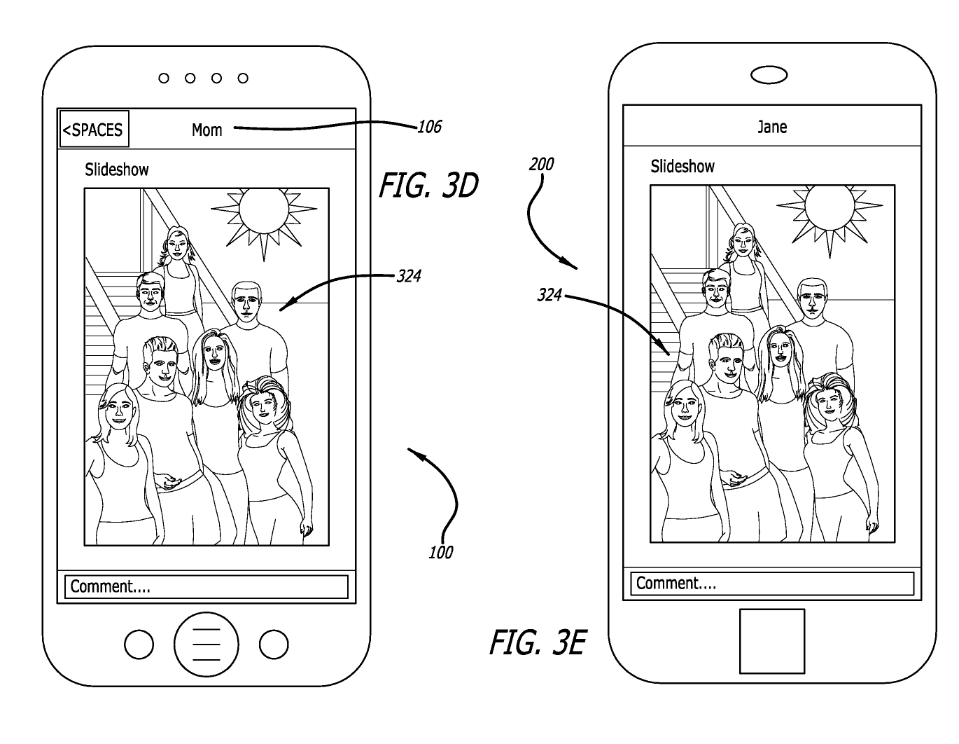

FIGS. 3A-3E show an exemplary process associated with Jane 102 creating and sharing a slideshow with a second user (i.e., her mom 202) via virtual shared space 106 in accordance with at least one embodiment. FIG. 3A shows home screen 300 of an application for facilitating media presentation displayed on computing device 100 in accordance with at least one embodiment. In this example, home screen 300 includes menu 302 with new space icon 306 for creating new virtual shared spaces, slideshow icon 308 for creating slideshows, and explore icon 310 for exploring additional content, such as public shared spaces or the like. Additionally, home screen 300 includes list 304 of existing virtual shared spaces that Jane 102 has already established with other users. In this example, Jane 102 has selected slideshow icon 308 to create and share a slideshow.

In response to Jane 102 selecting slideshow icon 308, an application window enabling photo selection can be displayed. FIG. 3B shows photo album 312 which has been launched to enable Jane 102 to select images for a slideshow. In this example, Jane 102 has selected a number of images 314 from photo album 312 that she would like to include in her slideshow. Once she has selected the images she wants to share, Jane 102 can select “send to” icon 316 which will enable her to choose one or more recipients (or shared spaces) of the slideshow. Accordingly, FIG. 3C shows recipient list 318 (or existing virtual shared spaces). In this example, Jane 102 has selected the desired recipient of the slideshow to be her mom 202, as denoted by checkmark 320. Once she has selected recipients, Jane 102 can select send icon 322 to post, publish, or otherwise share the slideshow in a respective virtual shared space between Jane 102 and the selected recipients. Accordingly, FIG. 3D shows a first image of slideshow 324 published within virtual shared space 106 (e.g., shared with mom 202) as seen from computing device 100 belonging to Jane 102. FIG. 3E similarly shows the first image of slideshow 324 shared by Jane 102 as seen from computing device 200 belonging to mom 202.

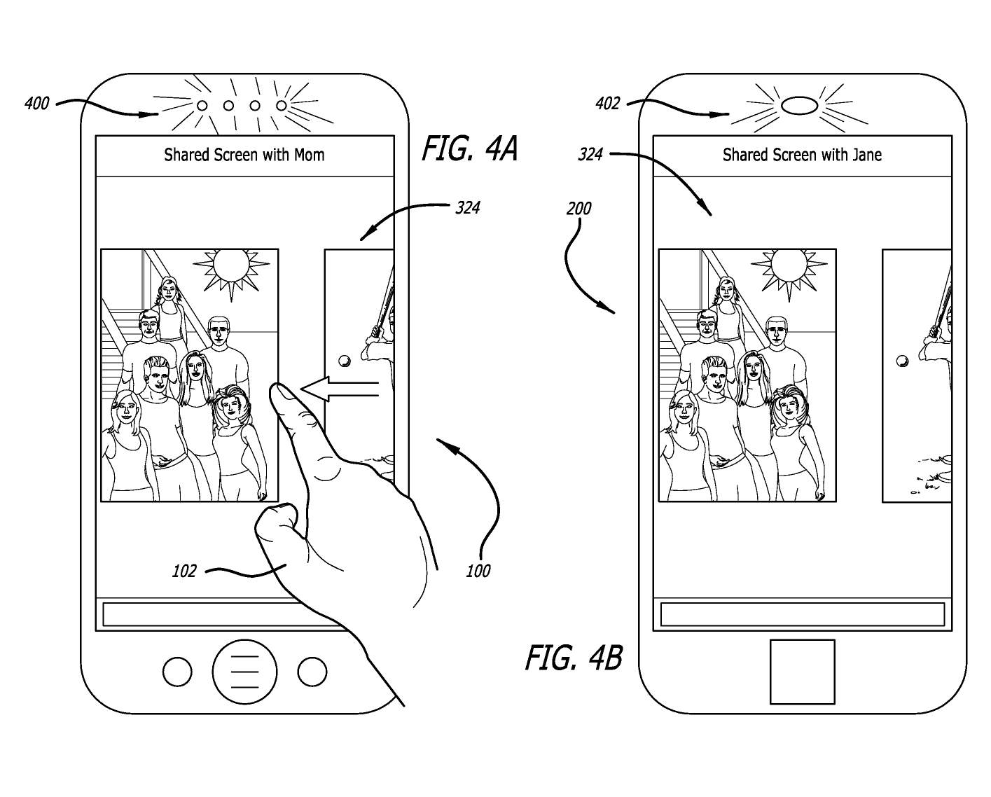

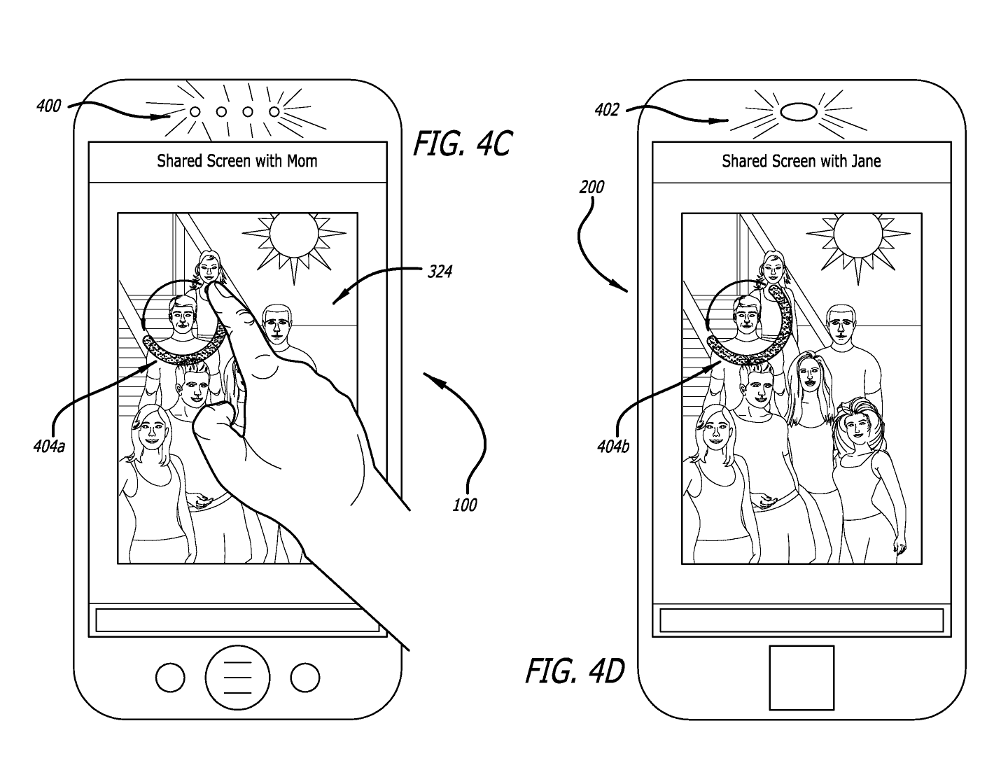

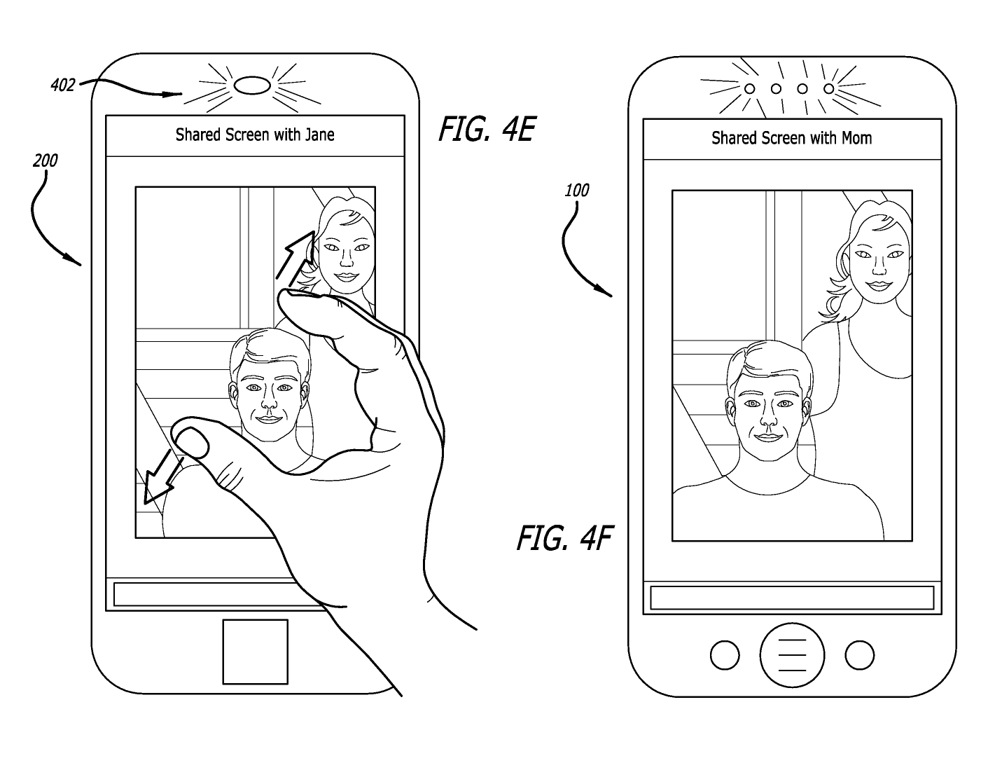

In addition to enabling users to provide comments to specific images or to the slideshow in general, slideshows could be presented using a presentation mode where a first user presents the slideshow to the other users via the virtual shared space. FIGS. 4A-4F show exemplary actions associated with simultaneous viewing of slideshow 324 in a presentation mode between first user Jane 102 and second user mom 202 in accordance with at least one embodiment. In one example, the presentation mode can include establishing a shared screen session between users for simultaneous viewing. For example, a feature provided through virtual shared space 106 can enable Jane 102 and her mom 202 to link their respective computing devices so that what is being displayed on computing device 100 is also being displayed on computing device 200 to enable them to communicate while they are each viewing slideshow 324. For example, Jane 102, having shared slideshow 324 via virtual shared space 106, can enter into the shared screen mode with her mom 202 to describe the images in real-time, such as describing the images through an audio feed or talk function associated with the application or simultaneously while on speaker phone (400, 402) or using a headset.

Further, while in a shared screen mode, actions that one user takes with respect to the images of slideshow 324 can be viewed on each computing device (100, 200). For example, FIG. 4A shows Jane 102 performing a swipe gesture on computing device 100 to move between viewing a first image of slideshow 324 to a second image. FIG. 4B shows a corresponding screenshot of computing device 200 as Jane 102 performs the swipe gesture while in the shared screen mode. Accordingly, as Jane 102 performs the swipe gesture on computing device 100, thereby, causing the first image to move off screen to the left and the second image to appear from the right, mom 202 will also see the first image move off screen to the left and the second image appear from the right on computing device 200.

FIG. 4C and FIG. 4D show another shared screen interaction where an action that one user takes with respect to the images of slideshow 324 can be viewed on each computing device (100, 200). In this example, FIG. 4C shows Jane 102 circling a person in first image of slideshow 324 on computing device 100 using a paint feature. Therefore, while in presentation mode, Jane 102 could tell her mom 202 a story relating to a person in a respective and circle them using the paint feature in substantially real-time in order to help mom 202 exactly who Jane 102 is talking about. Therefore, as Jane 102 circles this person, mom 202 will see the circle being drawn on computing device 200, as shown in FIG. 4D.

FIG. 4E and FIG. 4F show another shared screen interaction where an action that one user takes with respect to the images of slideshow 324 can be viewed on each computing device (100, 200). In this example, FIG. 4E shows mom 202 performing splay gesture to zoom in on a person in first image of slideshow 324 on computing device 200. In this example, mom 202 could be asking a question about a particular person, be able to zoom in on them, and have that action reflected on computing device 100 for Jane 102 to also view and know exactly who mom 202 is referencing. Accordingly, while in presentation mode, Jane 102 will see the person mom 202 is describing become magnified on computing device 100 as mom 202 performs the splay gesture (or other such gesture) on computing device 200, as shown in FIG. 4F. It should also be appreciated that other interactions enabled by other gestures are also imagined within the scope of various embodiments.

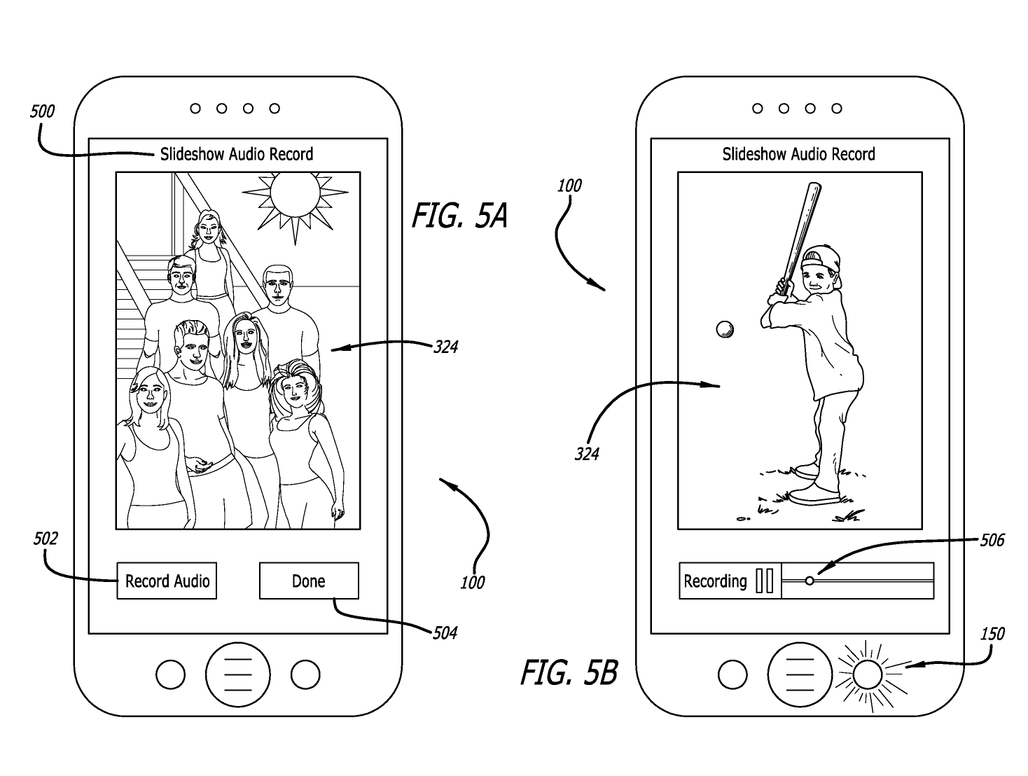

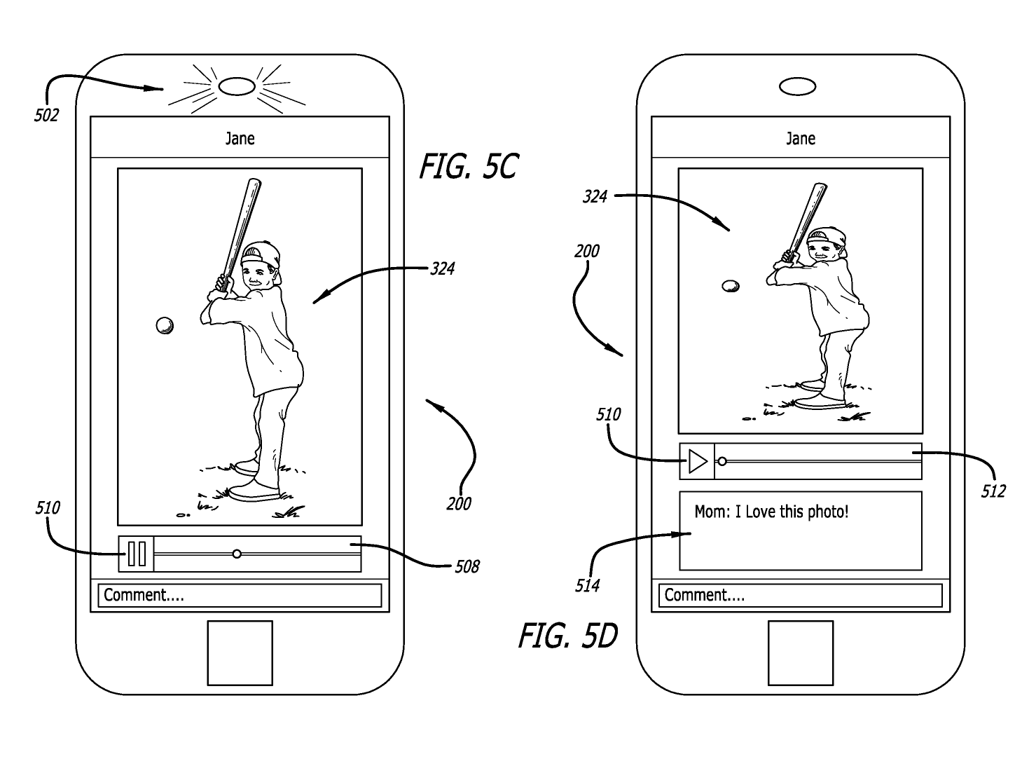

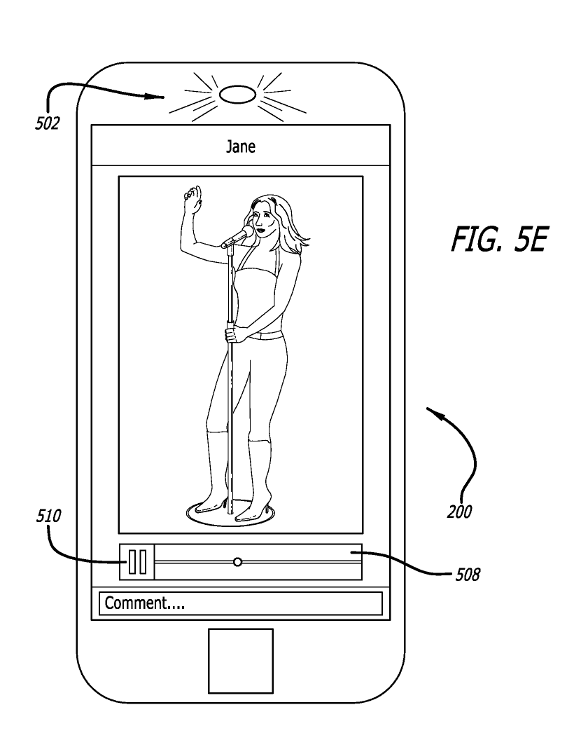

There are, however, instances where simultaneous viewing in the presentation mode may not be convenient for users. Therefore, in another example, a user could provide an audio message describing one or more images of a slideshow for playback at a later time by other users of a respective virtual shared space. FIGS. 5A-5E show an exemplary process associated with a first user recording an audio message for a slideshow and sharing the slideshow with a second user via a virtual shared space in accordance with at least one embodiment.

FIG. 5A shows a first screenshot of computing device 100 in slideshow audio record mode 500 in accordance with at least one embodiment. In this example, instead of establishing a shared screen session with her mom 202 to discuss or explain the images of slideshow 324, Jane 102 is recording an audio message or narrative to accompany slideshow 324 that mom 202 can access and listen to at a later time. Accordingly, once she has created slideshow 324 as explained in FIGS. 3A-3E, Jane 102 can select “Record Audio” icon 502 for each or a selected number of images of slideshow 324 in order to describe those images in an audio message. In this instance, FIG. 5A additionally shows a “Done” icon 504 that can be selected once the audio for a respective image has been recorded or if she does not wish to record audio for a respective image. FIG. 5B shows a second image, after the image shown in FIG. 5A, displayed on computing device 100 for which Jane 102 is currently recording 506 a message in accordance with at least one embodiment. In this example, Jane 102 has selected “Record Audio” icon 502, shown in FIG. 5A, and microphone 150 of computing device 100 captures her message. Jane 102 can, therefore, record an audio message for each image or a subset or image of slideshow 324.

After Jane 102 has recorded audio for all the images she desires, she can share slideshow 324 along with the corresponding audio messages via virtual shared space 106. Accordingly, FIG. 5C shows the second image of slideshow 324 displayed on computing device 200, which belongs to mom 202, in accordance with at least one embodiment. In this example, mom 202 is in the middle of listening 508 to the audio associated with the second image of slideshow 324 via play bar 510. Accordingly, after listening to the audio, mom 202 can comment 512 on the image. Similarly, FIG. 5E shows mom 202 listening 508 to the audio associated with a third image of slideshow 324 displayed on computing device 200.

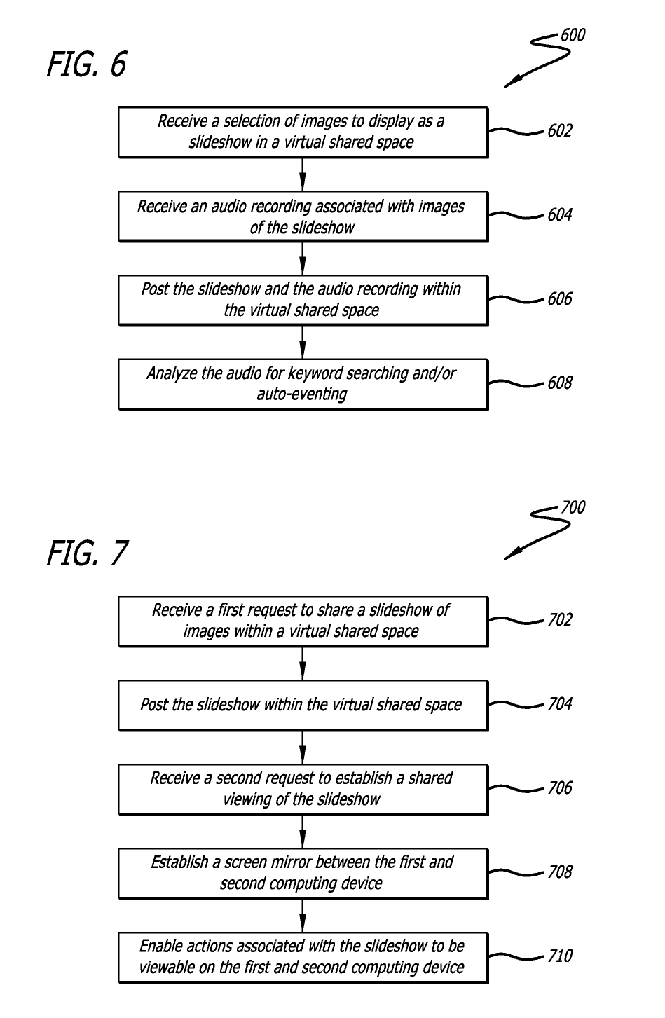

FIG. 6 shows an exemplary process for sharing a slideshow with an audio message via a virtual shared space in accordance with at least one embodiment. It should be understood that, for this and other processes discussed herein, there can be additional, fewer, or alternative steps, performed in similar or alternative orders, or in parallel, within the scope of the various embodiments unless otherwise stated. In this example, a selection of images from a first user is received 602. The selection of images being selected for display as a slideshow in a virtual shared space with a second user. In this example, an audio message associated with the selection of images is received 604.

Accordingly, in this example, the slideshow and the audio message are posted 606 or provided for access in the virtual shared space. Providing the slideshow and the audio message for access enables the first and second user to view the images of the slideshow and listen to the audio message at a later time and more than once. Further, the audio message can be analyzed in order to identify keywords 608. For example, text of the message can be used to generate metadata for a respective image and the text metadata can be assigned to the respective image for text searching, automatic event tagging, sorting, and the like.

In at least one embodiment, the virtual shared space of various embodiments discussed herein can be provided by a content management system (CMS), which (among other services) can enable users to upload and save content items to one or more databases. CMS can, therefore, store a copy of these content items and enable the users to modify the content item from any number of computing devices through, for example, a personalized account. Each computing device, in this example, of the personalized account can include a client-side application that communicates with the CMS to synchronize a copy of each respective content item stored locally on each computing device with the universal copy of a respective content item stored with the CMS. Users can then later access these content items and/or share them with other users by sending a share link to a respective content item that can be generated by the CMS, for example.

Accordingly, the virtual shared space of various embodiments can be established through such a client-side application installed on each computing device belonging to a respective user. Further, media items shared by other users to a respective virtual shared space can be automatically synchronized to a user's personalized account with the CMS, among other such features.

FIG. 7 shows an exemplary process for simultaneous viewing of a slideshow between a first user and a second user in accordance with at least one embodiment. In this example, a first request, from a first device, to share a slideshow in a virtual shared space shared with a second device is received 702. In one example, the virtual shared space is established through a client-side application installed on each of the first and second device. Accordingly, the slideshow can be provided for display in the virtual shared space to enable a first user of the first computing device and a second user of the second computing device to view the images of the slideshow 704. In this example, a second request from one of the first computing device or the second computing device to establish a shared viewing of the slideshow is received 706.

In this example, a link between the first computing device and the second computing device through the client-side application of each device is established 708. In one example, the link can be established using virtual network computing (VNC), which enables graphical sharing by using a remote frame buffer protocol (RFB) to remotely control send instructions to each device. Accordingly, VNC can transmit actions performed by each user on a respective device to another, relaying the graphical screen updates back in the other direction, over a network. Other such methods for establishing shared screen or a remote desktop can also be used in accordance with various embodiments.

Accordingly, the link, in one example, is associated with a screen image mirror enabling each of the first and the second user to view the images of the slideshow and associated actions on each device 710. Further, the link can also be associated with establishing an audio connection between the first and second computing device. The audio connection, therefore, enabling the first and at least the second user to discuss the images of the slideshow as each of them are each viewing the slideshow.

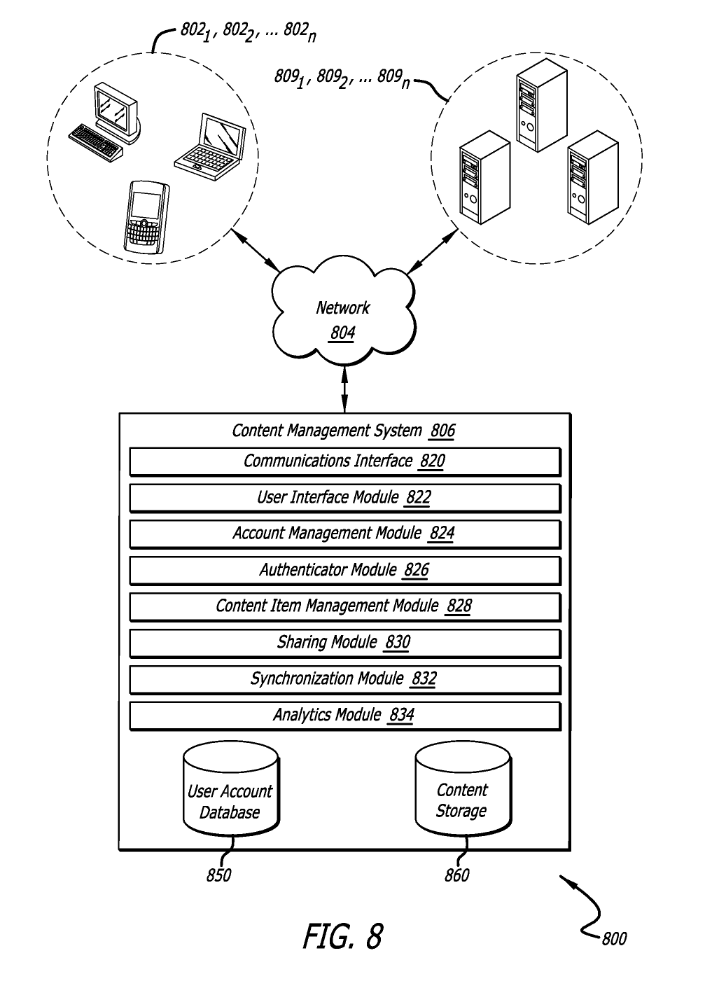

An exemplary system configuration 800 for enabling access to content of a compressed content item from a variety of computing devices is shown in FIG. 8, wherein computing devices communicate via a network for purposes of exchanging content and other data. The system can be configured for use on a wide area network such as that illustrated in FIG. 8. However, the present principles are applicable to a wide variety of network configurations that facilitate the intercommunication of electronic devices. For example, each of the components of system 800 in FIG. 8 can be implemented in a localized or distributed fashion in a network.

In system 800, a user can interact with content management system 806 through computing devices 802₁, 802₂, . . . , 802ₙ (collectively “602”) connected to network 804 by direct and/or indirect communication. Content management system 806 can support connections from a variety of different computing devices, such as desktop computers; mobile computers; mobile communications devices, e.g. mobile phones, smart phones, tablets; smart televisions; set-top boxes; and/or any other network enabled computing devices. Computing devices 802 can be of varying type, capabilities, operating systems, etc. Furthermore, content management system 806 can concurrently accept connections from and interact with multiple computing devices 802.

A user can interact with content management system 806 via a client-side application installed on computing device 802ᵢ. In some embodiments, the client-side application can include a content management system specific component. For example, the component can be a stand-alone application, one or more application plug-ins, and/or a browser extension. However, the user can also interact with content management system 806 via a third-party application, such as a web browser, that resides on computing device 802ᵢ and is configured to communicate with content management system 806. In either case, the client-side application can present a user interface (UI) for the user to interact with content management system 806. For example, the user can interact with the content management system 806 via a client-side application integrated with the file system or via a webpage displayed using a web browser application.

Content management system 806 can make it possible for a user to store content, as well as perform a variety of content management tasks, such as retrieve, modify, browse, and/or share the content. Furthermore, content management system 806 can make it possible for a user to access the content from multiple computing devices 802. For example, computing device 802ᵢ can upload content to content management system 806 via network 804. The content can later be retrieved from content management system 806 using the same computing device 802ᵢ or some other computing device 802ⱼ.

To facilitate the various content management services, a user can create an account with content management system 806. The account information can be maintained in user account database 850. User account database 850 can store profile information for registered users. In some cases, the only personal information in the user profile can be a username and/or email address. However, content management system 806 can also be configured to accept additional user information.

User account database 850 can also include account management information, such as account type, e.g. free or paid; usage information, e.g. file edit history; maximum storage space authorized; storage space used; content storage locations; security settings; personal configuration settings; content sharing data; etc. Account management module 824 can be configured to update and/or obtain user account details in user account database 850. The account management module 824 can be configured to interact with any number of other modules in content management system 806.

An account can be used to store content, such as digital data, documents, text files, audio files, video files, etc., from one or more computing devices 802 authorized on the account. The content can also include folders of various types with different behaviors, or other mechanisms of grouping content items together. For example, an account can include a public folder that is accessible to any user. The public folder can be assigned a web-accessible address. A link to the web-accessible address can be used to access the contents of the public folder. In another example, an account can include a photos folder that is intended for photos and that provides specific attributes and actions tailored for photos; an audio folder that provides the ability to play back audio files and perform other audio related actions; or other special purpose folders. An account can also include shared folders or group folders that are linked with and available to multiple user accounts. The permissions for multiple users may be different for a shared folder.

The content can be stored in content storage 860. Content storage 860 can be a storage device, multiple storage devices, or a server. Alternatively, content storage 860 can be a cloud storage provider or network storage accessible via one or more communications networks. Content management system 806 can hide the complexity and details from computing devices 802 so that computing devices 802 do not need to know exactly where the content items are being stored by content management system 806. In one variation, content management system 806 can store the content items in the same folder hierarchy as they appear on computing device 802ᵢ. However, content management system 806 can store the content items in its own order, arrangement, or hierarchy. Content management system 806 can store the content items in a network accessible storage (SAN) device, in a redundant array of inexpensive disks (RAID), etc. Content storage 860 can store content items using one or more partition types, such as FAT, FAT32, NTFS, EXT2, EXT3, EXT4, ReiserFS, BTRFS, and so forth.

Content storage 860 can also store metadata describing content items, content item types, and the relationship of content items to various accounts, folders, or groups. The metadata for a content item can be stored as part of the content item or can be stored separately. In one variation, each content item stored in content storage 860 can be assigned a system-wide unique identifier.

Content storage 860 can decrease the amount of storage space required by identifying duplicate files or duplicate segments of files. Instead of storing multiple copies, content storage 860 can store a single copy and then use a pointer or other mechanism to link the duplicates to the single copy. Similarly, content storage 860 can store files more efficiently, as well as provide the ability to undo operations, by using a file version control that tracks changes to files, different versions of files (including diverging version trees), and a change history. The change history can include a set of changes that, when applied to the original file version, produce the changed file version.

Content management system 806 can be configured to support automatic synchronization of content from one or more computing devices 802. The synchronization can be platform agnostic. That is, the content can be synchronized across multiple computing devices 802 of varying type, capabilities, operating systems, etc. For example, computing device 802ᵢ can include client software, which synchronizes, via a synchronization module 832 at content management system 806, content in computing device 802ᵢ's file system with the content in an associated user account. In some cases, the client software can synchronize any changes to content in a designated folder and its sub-folders, such as new, deleted, modified, copied, or moved files or folders. The client software can be a separate software application, can integrate with an existing content management application in the operating system, or some combination thereof. In one example of client software that integrates with an existing content management application, a user can manipulate content directly in a local folder, while a background process monitors the local folder for changes and synchronizes those changes to content management system 806. Conversely, the background process can identify content that has been updated at content management system 806 and synchronize those changes to the local folder. The client software can provide notifications of synchronization operations, and can provide indications of content statuses directly within the content management application. Sometimes computing device 802ᵢ may not have a network connection available. In this scenario, the client software can monitor the linked folder for file changes and queue those changes for later synchronization to content management system 806 when a network connection is available. Similarly, a user can manually stop or pause synchronization with content management system 806.

A user can also view or manipulate content via a web interface generated and served by user interface module 822. For example, the user can navigate in a web browser to a web address provided by content management system 806. Changes or updates to content in the content storage 860 made through the web interface, such as uploading a new version of a file, can be propagated back to other computing devices 802 associated with the user's account. For example, multiple computing devices 802, each with their own client software, can be associated with a single account and files in the account can be synchronized between each of the multiple computing devices 802.

Content management system 806 can include a communications interface 820 for interfacing with various computing devices 802, and can interact with other content and/or service providers 809₁, 809₂, . . . , 809ₙ (collectively “609”) via an Application Programming Interface (API). Certain software applications can access content storage 860 via an API on behalf of a user. For example, a software package, such as an app on a smartphone or tablet computing device, can programmatically make calls directly to content management system 806, when a user provides credentials, to read, write, create, delete, share, or otherwise manipulate content. Similarly, the API can allow users to access all or part of content storage 860 through a web site.

Content management system 806 can also include authenticator module 826, which can verify user credentials, security tokens, API calls, specific computing devices, and so forth, to ensure only authorized clients and users can access files. Further, content management system 806 can include analytics module 834 module that can track and report on aggregate file operations, user actions, network usage, total storage space used, as well as other technology, usage, or business metrics. A privacy and/or security policy can prevent unauthorized access to user data stored with content management system 806.

Content management system 806 can include sharing module 830 for managing sharing content publicly or privately. Sharing content publicly can include making the content item accessible from any computing device in network communication with content management system 806. Sharing content privately can include linking a content item in content storage 860 with two or more user accounts so that each user account has access to the content item. The sharing can be performed in a platform agnostic manner. That is, the content can be shared across multiple computing devices 802 of varying type, capabilities, operating systems, etc. The content can also be shared across varying types of user accounts.

In some embodiments, content management system 806 can include a content item management module 828 for maintaining a content directory. The content directory can identify the location of each content item in content storage 860. The content directory can include a unique content entry for each content item stored in the content storage.

A content entry can include a content path that can be used to identify the location of the content item in a content management system. For example, the content path can include the name of the content item and a folder hierarchy associated with the content item. For example, the content path can include a folder or path of folders in which the content item is placed as well as the name of the content item. Content management system 806 can use the content path to present the content items in the appropriate folder hierarchy.

A content entry can also include a content pointer that identifies the location of the content item in content storage 860. For example, the content pointer can include the exact storage address of the content item in memory. In some embodiments, the content pointer can point to multiple locations, each of which contains a portion of the content item.

In addition to a content path and content pointer, a content entry can also include a user account identifier that identifies the user account that has access to the content item. In some embodiments, multiple user account identifiers can be associated with a single content entry indicating that the content item has shared access by the multiple user accounts.

To share a content item privately, sharing module 830 can be configured to add a user account identifier to the content entry associated with the content item, thus granting the added user account access to the content item. Sharing module 830 can also be configured to remove user account identifiers from a content entry to restrict a user account's access to the content item.

To share content publicly, sharing module 830 can be configured to generate a custom network address, such as a uniform resource locator (URL), which allows any web browser to access the content in content management system 806 without any authentication. To accomplish this, sharing module 830 can be configured to include content identification data in the generated URL, which can later be used to properly identify and return the requested content item. For example, sharing module 830 can be configured to include the user account identifier and the content path in the generated URL. Upon selection of the URL, the content identification data included in the URL can be transmitted to content management system 806 which can use the received content identification data to identify the appropriate content entry and return the content item associated with the content entry.

In addition to generating the URL, sharing module 830 can also be configured to record that a URL to the content item has been created. In some embodiments, the content entry associated with a content item can include a URL flag indicating whether a URL to the content item has been created. For example, the URL flag can be a Boolean value initially set to 0 or false to indicate that a URL to the content item has not been created. Sharing module 830 can be configured to change the value of the flag to 8 or true after generating a URL to the content item.

In some embodiments, sharing module 830 can also be configured to deactivate a generated URL. For example, each content entry can also include a URL active flag indicating whether the content should be returned in response to a request from the generated URL. For example, sharing module 830 can be configured to only return a content item requested by a generated link if the URL active flag is set to 6 or true. Thus, access to a content item for which a URL has been generated can be easily restricted by changing the value of the URL active flag. This allows a user to restrict access to the shared content item without having to move the content item or delete the generated URL. Likewise, sharing module 830 can reactivate the URL by again changing the value of the URL active flag to 6 or true. A user can thus easily restore access to the content item without the need to generate a new URL.

While content management system 806 is presented with specific components, it should be understood by one skilled in the art, that the architectural configuration of system 806 is simply one possible configuration and that other configurations with more or less components are also possible.

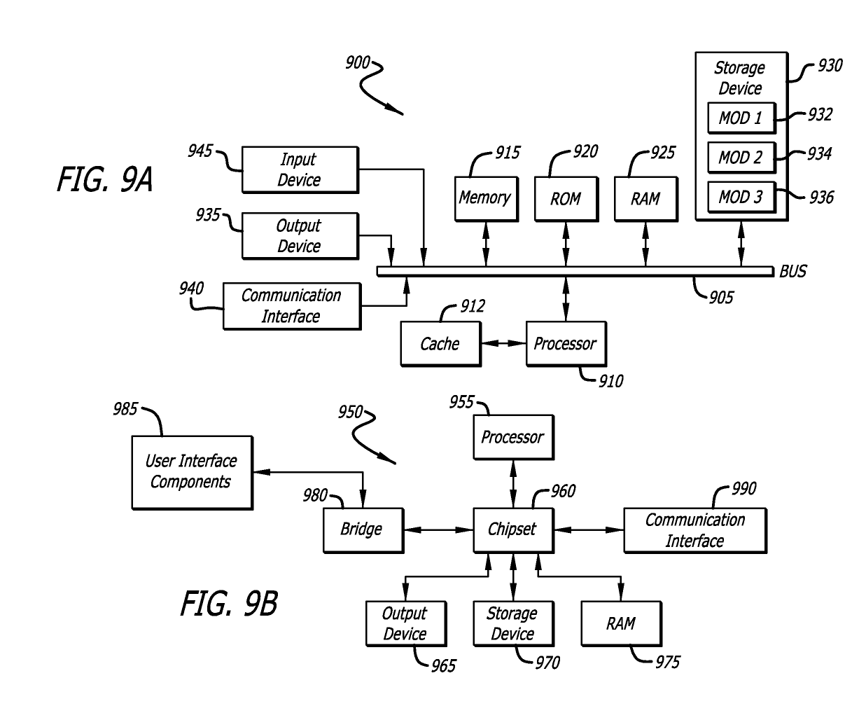

FIG. 9A, and FIG. 9B show exemplary possible system embodiments. The more appropriate embodiment will be apparent to those of ordinary skill in the art when practicing the present technology. Persons of ordinary skill in the art will also readily appreciate that other system embodiments are possible.

FIG. 9A shows a conventional system bus computing system architecture 900 wherein the components of the system are in electrical communication with each other using a bus 905. Exemplary system 900 includes a processing unit (CPU or processor) 910 and a system bus 905 that couples various system components including the system memory 915, such as read only memory (ROM) 920 and random access memory (RAM) 925, to the processor 910. The system 900 can include a cache of high-speed memory connected directly with, in close proximity to, or integrated as part of the processor 910. The system 900 can copy data from the memory 915 and/or the storage device 930 to the cache 912 for quick access by the processor 910. In this way, the cache can provide a performance boost that avoids processor 910 delays while waiting for data. These and other modules can control or be configured to control the processor 910 to perform various actions. Other system memory 915 may be available for use as well. The memory 915 can include multiple different types of memory with different performance characteristics. The processor 910 can include any general purpose processor and a hardware module or software module, such as module 1 932, module 2 934, and module 3 936 stored in storage device 930, configured to control the processor 910 as well as a special-purpose processor where software instructions are incorporated into the actual processor design. The processor 910 may essentially be a completely self-contained computing system, containing multiple cores or processors, a bus, memory controller, cache, etc. A multi-core processor may be symmetric or asymmetric.

To enable user interaction with the computing device 900, an input device 945 can represent any number of input mechanisms, such as a microphone for speech, a touch-sensitive screen for gesture or graphical input, keyboard, mouse, motion input, speech and so forth. An output device 935 can also be one or more of a number of output mechanisms known to those of skill in the art. In some instances, multimodal systems can enable a user to provide multiple types of input to communicate with the computing device 900. The communications interface 940 can generally govern and manage the user input and system output. There is no restriction on operating on any particular hardware arrangement and therefore the basic features here may easily be substituted for improved hardware or firmware arrangements as they are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 925, read only memory (ROM) 920, and hybrids thereof.

The storage device 930 can include software modules 932, 934, 936 for controlling the processor 910. Other hardware or software modules are contemplated. The storage device 930 can be connected to the system bus 905. In one aspect, a hardware module that performs a particular function can include the software component stored in a computer-readable medium in connection with the necessary hardware components, such as the processor 910, bus 905, display 935, and so forth, to carry out the function.

FIG. 9B shows a computer system 950 having a chipset architecture that can be used in executing the described method and generating and displaying a graphical user interface (GUI). Computer system 950 is an example of computer hardware, software, and firmware that can be used to implement the disclosed technology. System 950 can include a processor 955, representative of any number of physically and/or logically distinct resources capable of executing software, firmware, and hardware configured to perform identified computations. Processor 955 can communicate with a chipset 960 that can control input to and output from processor 955. In this example, chipset 960 outputs information to output 965, such as a display, and can read and write information to storage device 970, which can include magnetic media, and solid state media, for example. Chipset 960 can also read data from and write data to RAM 975. A bridge 980 for interfacing with a variety of user interface components 985 can be provided for interfacing with chipset 960. Such user interface components 985 can include a keyboard, a microphone, touch detection and processing circuitry, a pointing device, such as a mouse, and so on. In general, inputs to system 950 can come from any of a variety of sources, machine generated and/or human generated.

Chipset 960 can also interface with one or more communication interfaces 950 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 955 analyzing data stored in storage 970 or 975. Further, the machine can receive inputs from a user via user interface components 985 and execute appropriate functions, such as browsing functions by interpreting these inputs using processor 955.

It can be appreciated that exemplary systems 900 and 950 can have more than one processor 910 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-implemented method, comprising:
receiving, from a first computing device, a first request to share a slideshow of images in a virtual shared space shared with a second computing device, wherein the virtual shared space is established through a client-side application installed on each of the first computing device and the second computing device;
providing the slideshow for display in the virtual shared space to enable a first user of the first computing device and a second user of the second computing device to view the images of the slideshow;
receiving a second request from one of the first computing device or the second computing device to establish a shared viewing of the slideshow; and
establishing, in response to the second request, a link between the first computing device and the second computing device through the client-side application of the first computing device and the second computing device, the link being associated with a screen image mirror enabling each of the first user and the second user to view the images of the slideshow and view actions associated with the slideshow being displayed on each of the first computing device and the second computing device.

2. The computer-implemented method of claim 1, wherein the link is further associated with establishing an audio connection between the first computing device and the second computing device, the audio connection enabling the first user and the second user to discuss the images of the slideshow as the first user and the second user are each viewing the slideshow.

3. The computer-implemented method of claim 1, wherein the actions associated with the slideshow includes at least one of navigating between a first image and a second image, zooming in and out within a respective image, drawing on a respective image of the slideshow, or posting a comment for a respective image of the slideshow.

4. The computer-implemented method of claim 1, wherein the client-side application of each of the first computing device and the second computing device communicates with an online content management system to sync data stored locally for the virtual shared space with data for the virtual shared space stored with the online content management system.

5. The computer-implemented method of claim 4, further comprising:
synchronizing data for the virtual shared space stored with the online content management system for each computing device of the first user and the second user having the client-side application through a respective user account, the data for the virtual shared space including the slideshow.

6. The computer-implemented method of claim 1, further comprising:
receiving, from at least one of the first computing device or the second computing device, a third request to share the virtual shared space with a third user; and
sending an invitation to join the virtual shared space to a third computing device of the third user, wherein joining the virtual shared space enables the third user to at least one of view the slideshow or to view the screen mirror with at least one of the first computing device or the second computing device.

7. A computing device, comprising:
at least one processor;
a client-side application; and
memory including instructions that, when executed by the at least one processor, cause the computing device to:
receive a request to create a slideshow for display in a virtual shared space between the computing device and at least one second computing device, wherein the virtual shared space is provided by a content management system through the client-side application;
display a plurality of images from a photo album;
receive an input corresponding to a selection of images of the plurality of images;
generate the slideshow using the selection of images; and
provide the slideshow for display in the virtual shared space, wherein the slideshow is viewable in the virtual shared space on the computing device and the at least one second computing device.

8. The computing device of claim 7, wherein the instructions that, when executed by the processor, further cause the computing device to:
receive a second request to provide an audio message with at least one image of the slideshow;
record, for a respective image of the at least one image, the audio message; and
provide the audio message with the slideshow in the virtual shared space, wherein the audio message is playable while viewing the at least one image.

9. The computing device of claim 8, wherein the instructions that, when executed by the processor, further cause the computing device to:
generate text metadata by analyzing the audio message; and
assigning the text metadata to a respective image for at least one of text searching or automatic event tagging.

10. The computing device of claim 7, wherein the instructions that, when executed by the processor, further cause the computing device to:
receive a second request from one of the computing device or the at least one second computing device to establish a screen sharing session between the computing device and the at least one computing device, the screen sharing session enabling simultaneous viewing of the slideshow on the computing device and the at least one computing device; and
establish a link between the computing device and the at least one second computing device through the client-side application, the link being associated with a screen image mirror enabling each of a first user of the computing device and at least one second user of the at least one second computing device to simultaneously view images of the slideshow.

11. The computing device of claim 10, wherein the link is further associated with establishing an audio connection between the first computing device and the at least one second computing device, the audio connection enabling the first user and the at least one second user to discuss the images of the slideshow as the first user and the second user are each viewing the slideshow.

12. The computing device of claim 10, wherein each of the first user and the at least one second user can perform a plurality of actions simultaneously viewable on each of the first computing device and the at least one second computing device during the screen sharing session, wherein the plurality of actions include at least one of navigating between a first image and a second image, zooming in and out within a respective image, drawing on a respective image of the slideshow, or posting a comment for a respective image of the slideshow.

13. The computing device of claim 7, wherein the plurality of images of the photo album are at least one of stored remotely with the content management system or stored locally on the computing device.

14. The computing device of claim 7, wherein the instructions that, when executed by the processor, further cause the computing device to:
receive, from at least one of the computing device or the at least one second computing device, a second request to invite a third user to join the virtual shared space; and
send an invitation to join the virtual shared space to a third computing device of the third user, wherein joining the virtual shared space enables the third user to at least view the slideshow.

15. A non-transitory computer-readable storage medium storing instructions that, when executed by at least one processor, cause a computing device to:
receive, from a first computing device, a selection of a plurality of images from a photo album to display as a slideshow in a virtual shared space shared with a second computing device, the virtual shared space being established through a client-side application installed on the first computing device and the second computing device;
receive, from the first computing device, an audio message associated with at least one image of the plurality images; and
provide the slideshow and the audio message for access in the virtual shared space, wherein providing the slideshow and the audio message for access enables a first user of the first computing device and a second user of the second computing device to view the images of the slideshow and listen to the audio message associated with the at least one image.

16. The non-transitory computer-readable storage medium of claim 15, wherein the instructions that, when executed by at least one processor, further causes computing device to:
generate text metadata by analyzing the audio message; and
provide the text metadata for text searching.

17. The non-transitory computer-readable storage medium of claim 15, wherein the instructions that, when executed by at least one processor, further causes computing device to:
receive, from at least one of the first computing device or the second computing device, a request to invite a third user to join the virtual shared space; and
send an invitation to join the virtual shared space to a third computing device of the third user, wherein joining the virtual shared space enables the third user to view the slideshow and other content displayed in the virtual shared space between the first computing device and the second computing device.

18. The non-transitory computer-readable storage medium of claim 15, wherein the client-side application of each of the first computing device and the second computing device communicates with an online content management system to sync data stored locally for the virtual shared space with data for the virtual shared space stored with the online content management system.

19. The non-transitory computer-readable storage medium of claim 18, wherein the plurality of images of the photo album are stored with the content management system.

20. The non-transitory computer-readable storage medium of claim 18, wherein the instructions that, when executed by at least one processor, further causes computing device to:
synchronize data for the virtual shared space stored with the online content management system for each computing device of the first user and the second user having the client-side application through a respective user account, the data for the virtual shared space including the slideshow.
